(19) United States
(12) Patent Application Publication
(10) Pub. No.: US 2009/0057952 A1
(43) Pub. Date: Mar. 5, 2009

(54) MOLDING APPARATUS AND INJECTION MOLDING METHOD USING THE SAME

(75) Inventors: Ick-Sung CHOE, Yongin-si (KR); Young-Ki KIM, Yongin-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/199,288

(22) Filed: Aug. 27, 2008

(30) Foreign Application Priority Data
Sep. 5, 2007 (KR) 10-2007-89946

(51) Int. Cl. B28B 5/04

(52) U.S. Cl. 264/294; 249/102

(57) ABSTRACT

A molding apparatus and an injection molding method using the same are provided. A plurality of lower mold cores are arranged in a first direction, and a plurality of upper mold cores are arranged in a row in the first direction. At least one of the lower mold cores is movable into contact with the upper mold cores.

### CROSS-REFERENCE TO RELATED APPLICATION

This application claims priority from and the benefit of Korean Patent Application No. 10-2007-89946, filed on Sep. 5, 2007, which is hereby incorporated by reference for all purposes as if fully set forth herein.

### BACKGROUND OF THE INVENTION

1. Field of the Invention

The present invention generally relates to a molding apparatus and an injection molding method using the same. More particularly, the present invention relates to an injection molding method for enabling molding of a single product by a single molding apparatus and enabling multi-shot injection molding using the molded single product.

2. Discussion of the Background

In general, injection molding is a synthetic resin molding technology in which a mold is fabricated in the shape of an intended injection-molded part and melted synthetic resin is filled in the mold and cooled. Injection molding has a wide range of applications spanning from simple products such as kitchen utensils to electronic devices such as a home-use wired phone, an MP3 player, a portable phone, and an electronic notepad.

Injection molding is widely used despite high mold fabrication costs because it is favorable for mass production of standard products as it provides products having constant quality, once a mold is fabricated.

Along with the development of the ultra high speed wired/wireless Internet and mobile communication services, portable electronic devices, for example, a portable phone, an electronic notepad, an MP3 player, and a portable multimedia player, are proliferated, thus driving further production of injection-molded products. Also, the popularity of portable electronic devices has increased the demand for portable electronic devices that can operate normally even under unfavorable environment conditions in terms of dust, humidity, and temperature. Portable electronic devices should also be waterproof so that they can operate normally even in the rain.

A waterproof portable electronic device may have a seal, such as a gasket, applied to the inner wall of a case or an additional waterproof frame covering a circuit board within the case. Such a waterproof portable electronic device is disclosed in U.S. Patent Application Publication No. 2006/0050903 (Mar. 9, 2006). The waterproof portable electronic device may be complex to fabricate and less portable because of the thickness of its seal or its waterproof frame.

A non-waterproof portable electronic device may be carried in a waterproof pack as disclosed in U.S. Patent Application Publication No. 2006/0274493 (Dec. 7, 2006). However, the waterproof pack should be carried in addition to the non-waterproof portable electronic device, which may be inconvenient.

### SUMMARY OF THE INVENTION

The present invention provides a molding apparatus to facilitate fabrication of the case of a waterproof electronic device and an injection molding method using the same.

The present invention also provides a molding apparatus that may provide for the miniaturization of electronic devices and an injection molding method using the same.

The present invention also provides an injection molding method for molding a plurality of parts to a single product without a separate assembly process by multi-shot injection molding in a single molding apparatus.

Additional features of the invention will be set forth in the description which follows, and in part will be apparent from the description, or may be learned by practice of the invention.

The present invention discloses a molding apparatus including a plurality of lower mold cores arranged in a first direction, and a plurality of upper mold cores arranged in a row in the first direction. At least one lower mold core is moveable to a first position corresponding to a first upper mold core and to a second position corresponding to a second upper mold core

The present invention also discloses an injection molding method, in which a first molding step includes molding a frame by bringing a first lower mold core and a first upper mold core into contact with each other. The first lower mold core is one of a plurality of lower mold cores arranged in a row in a first direction, and the first upper mold core is one of a plurality of upper mold cores arranged in a row in the first direction. The method further includes a second molding step for performing multi-shot injection molding by bringing the first lower mold core and a second upper mold core into contact with each other while the frame is positioned in the first lower mold core, or by bringing the first upper mold core and a second lower mold core into contact with each other while the frame is positioned in the first upper mold core.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a flowchart showing an injection molding method using a molding apparatus according to an exemplary embodiment of the present invention.

FIG. 2A, FIG. 2B, and FIG. 2C sequentially show a first molding step in the injection molding method shown in FIG. 1.

FIG. 3A, FIG. 3B, and FIG. 3C sequentially show a second molding step in the injection molding method shown in FIG. 1.

FIG. 4A, FIG. 4B, and FIG. 4C sequentially show a third molding step in the injection molding method shown in FIG. 1.

FIG. 5A shows an ejection step in the injection molding method shown in FIG. 1.

FIG. 5B shows an operation of the molding apparatus after the ejection step in the injection molding method shown in FIG. 1.

FIG. 6 is a perspective view of an injection-molded part resulting from the first molding step shown in FIG. 2A, FIG. 2B, and FIG. 2C.

FIG. 7 is a perspective view of an injection-molded part resulting from the second molding step shown in FIG. 3A, FIG. 3B, and FIG. 3C.

FIG. 8 is a perspective view of an injection-molded part resulting from the third molding step shown in FIG. 4A, FIG. 4B and FIG. 4C.

FIG. 9 is a perspective view of a case for a portable electronic device, fabricated with the injection-molded parts formed by the injection molding method shown in FIG. 1.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

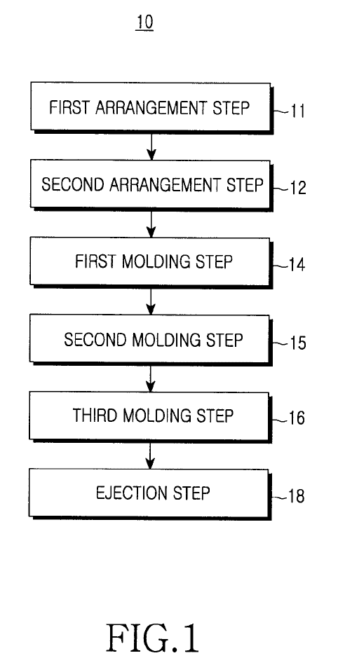

FIG. 1 is a flowchart showing an injection molding method 10 using a molding apparatus according to an exemplary embodiment of the present invention. Referring to FIG. 1, the injection molding method 10 sequentially involves first and second arrangement steps (11) and (12), first, second, and third molding steps (14), (15), and (16), and an ejection step (18) to remove an injection-molded part.

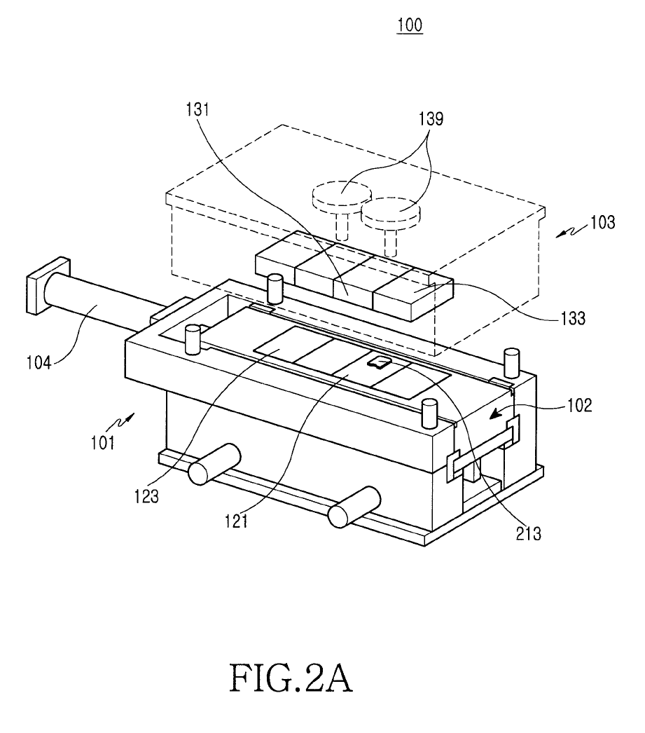

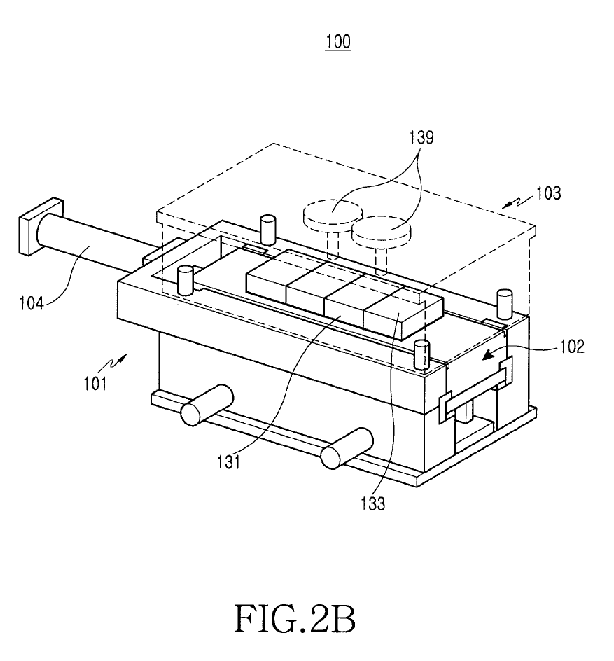

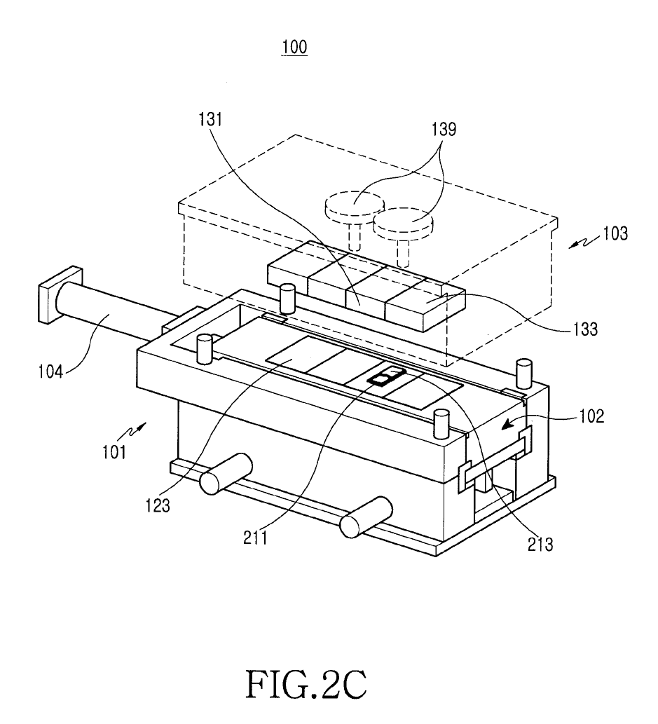

In the first and second arrangement steps (11) and (12), molding cores are arranged and set. Then the first, second, and third molding steps (14), (15), and (16) can be repeated without performing the first and second arrangement steps (11) and (12) unless a mold is worn away or an intended product to be injection-molded is modified. Hence, now a description will be made of the first, second, and third molding steps (14), (15), and (16) and the first and second arrangement steps (11) and (12) will be described in detail with reference to FIG. 2A.

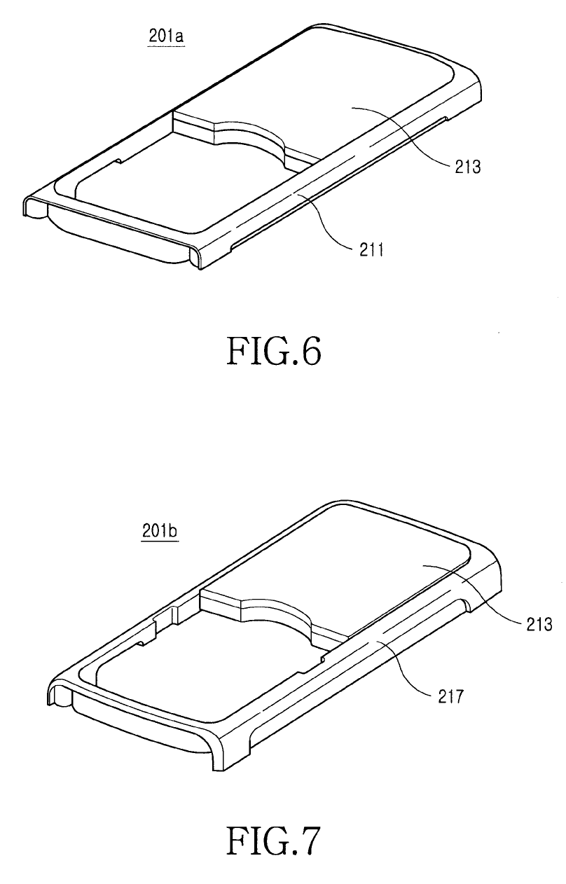

In the first molding step (14), an already injection-molded part is inserted and multi-shot injection molding is performed. FIG. 6 shows a first frame 201a fabricated by the first molding step 14. The first frame 201a is a molded part of a front cover 201 of a portable electronic device, as shown in FIG. 9. To be more specific, the first frame 201a is molded with a window 213 attached to a frame 211 of the front cover 201. The window 213 may be molded before the first molding step (14) and it may be made of a transparent material so that a screen can be viewed. With the pre-molded window 213 being inserted into the mold before molding the first frame 201a, melted resin is introduced, thereby simultaneously molding the frame 211 and attaching the window 213 to the frame 211. Thus, waterproofing may be achieved between the window 213 and the frame 211.

If the frame 211 is also made of a transparent material to allow a user to view the screen, a film with a product brand or a communication service provider logo printed therein may be inserted into the mold to integrally mold the window 213 and the frame 211. The film inserted into the mold may form the periphery of the screen along the edges of the window 213.

As shown in FIG. 7, a second frame 210b is formed by applying a coating 217 to the outer circumferential surface of the frame 211 in the second molding step (15). The coating 217 is used to enhance the appearance or tactile feeling of the outer circumferential surface of the frame 211. The coating 217 may be made of a different material than the frame 211. For example, if the frame 211 is made of a hard synthetic resin, the coating 217 may be made of an elastomer resin to render it soft. Also, the frame 211 and the coating 217 may be in different colors to make a decorative effect on the outer looks of the frame 211. That is, the second molding step (15) may decorate the injection-molded part with multiple colors by multi-shot injection molding.

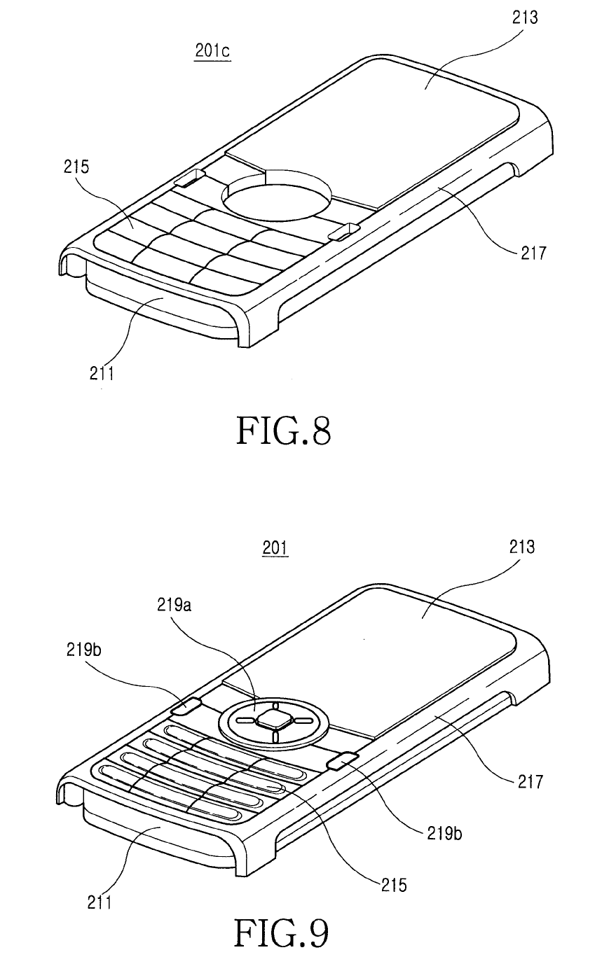

In the third molding step (16), a keypad 215 is attached to the second frame 210b, as shown in FIG. 8. The keypad 215 is pre-molded and inserted into the mold together with the second frame 201b and mold alignment is performed. Then, the periphery of the keypad 215 is brought into contact with the inner surface of the second frame 201b, while the outer surface of the keypad 215 is exposed outward through an opening of the second frame 201b. After mold alignment, resin is introduced between the contact surfaces of the keypad 215 and the second frame 201b and hardened. As a result, the keypad 215 is attached and sealed to the second frame 201b, thereby waterproofing the connection between the keypad 215 and the second frame 201b. The keypad 215 may be made of an elastic material, such as silicon or urethane, so as to transfer user input to a dome switch and return to its original position in the absence of user input. Keys 219a and 219b of the keypad 215 may be hard injection-molded parts that are attached to the keypad 215.

The use of multi-shot injection molding in attaching the window 213 and the keypad 215 to the frame 211 of the front cover 201 may make the case of the portable electronic device waterproof without a separate waterproofing process. While the coating 217 is molded in the second step (15) and the keypad 215 is attached and sealed in the third molding step (16), the attachment of the coating 217 and the keypad 215 are independent of each other and thus there is no need to attach the coating 217 first and then the keypad 215 in this order. That is, the order in which components are molded and attached to enhance the appearance, such as the coating 217 as well as input/output components including the window 213 and the keypad 215 in the frame 211, may vary depending on the characteristics of a product.

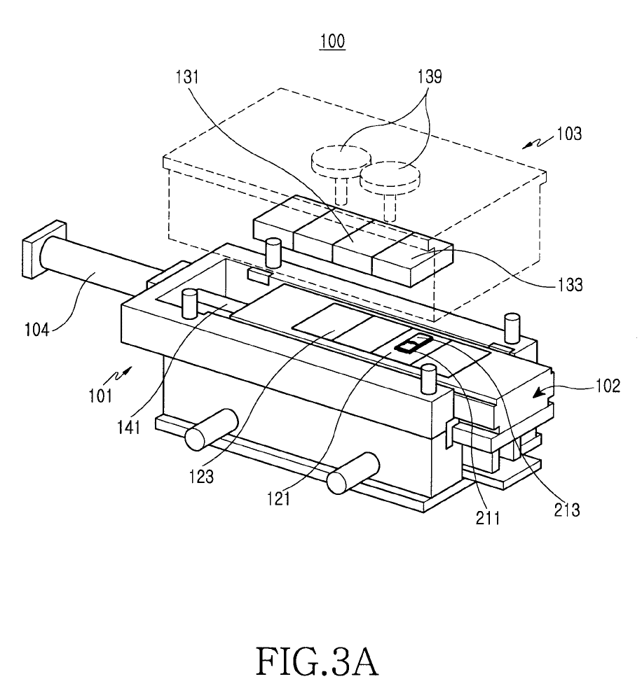

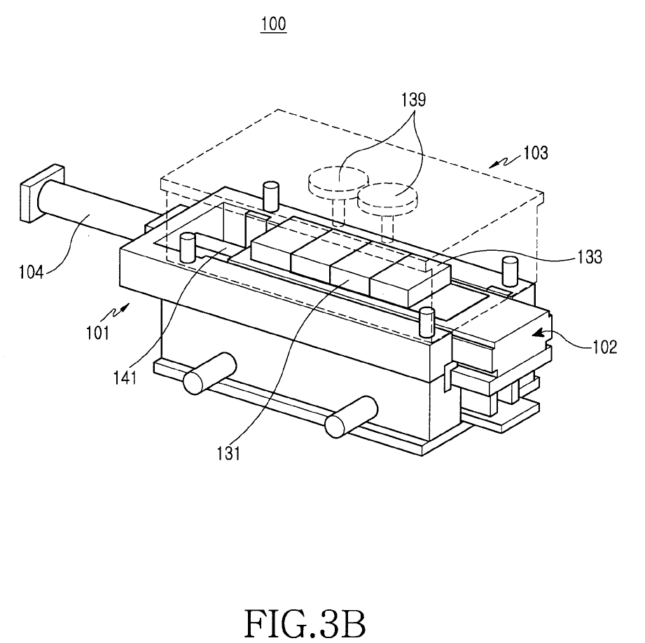

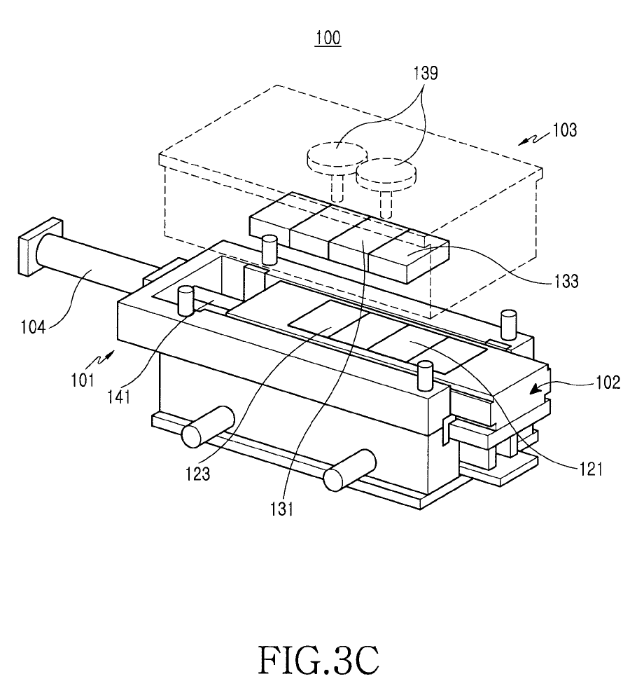

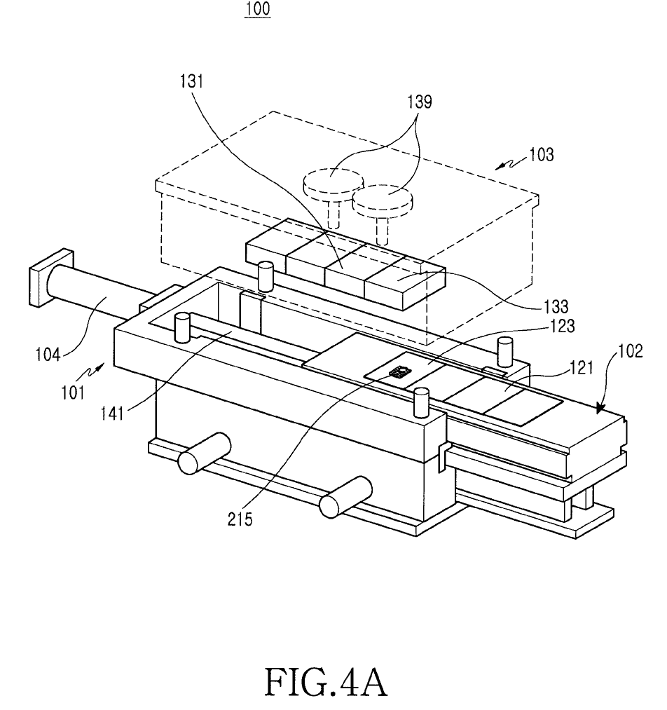

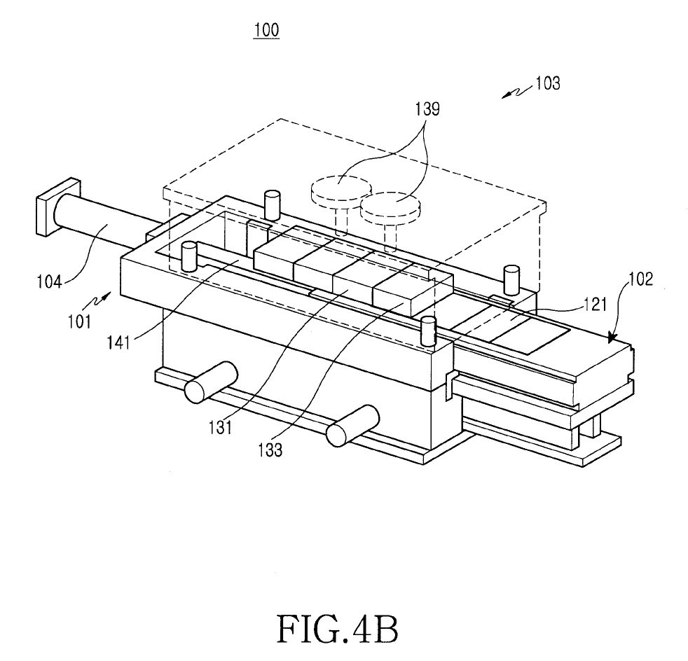

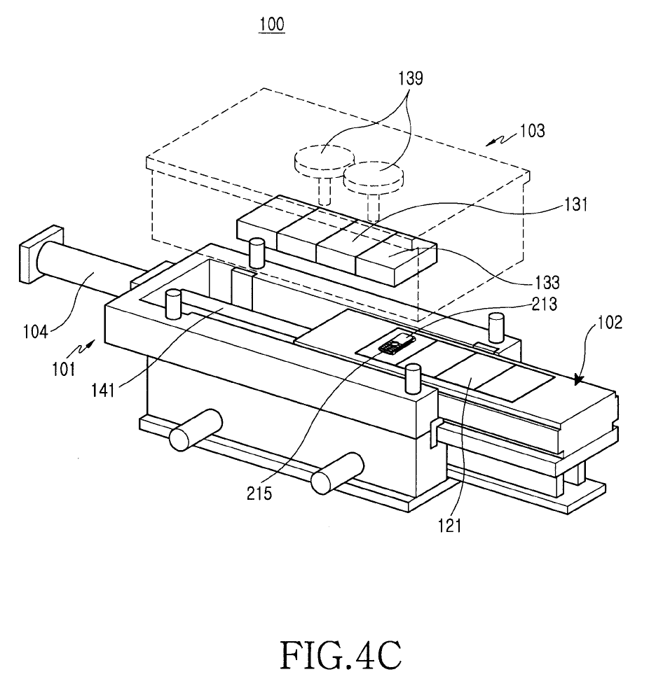

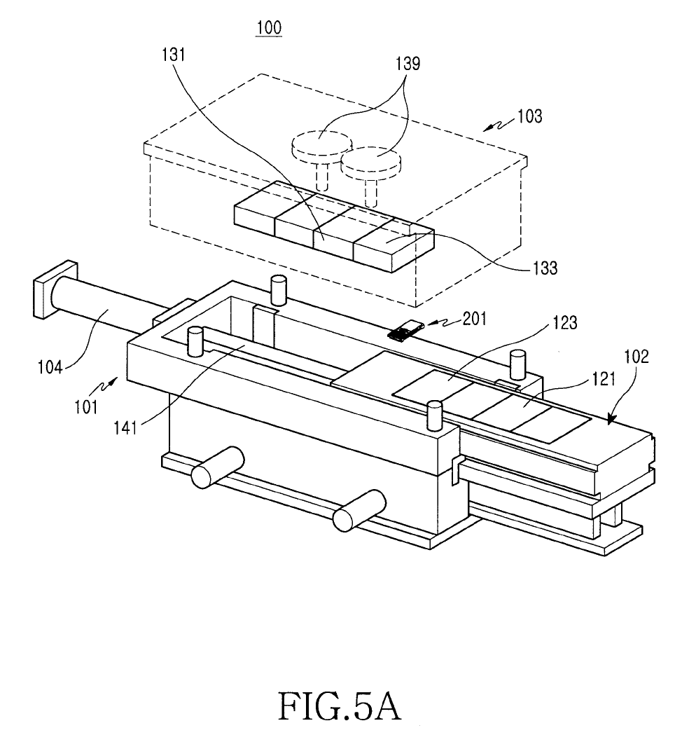

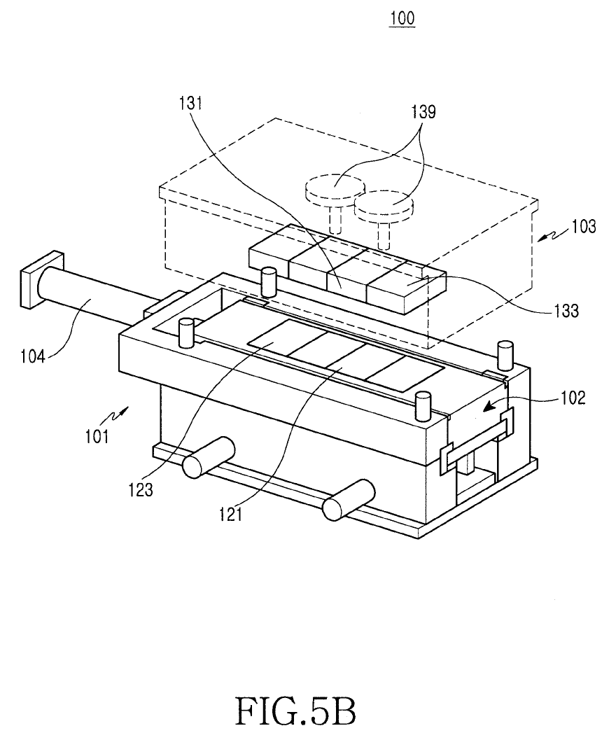

With reference to FIG. 2A, FIG. 2B, FIG. 2C, FIG. 3A, FIG. 3B, FIG. 3C, FIG. 4A, FIG. 4B, FIG. 4C, FIG. 5A, and FIG. 5B, an example of the molding apparatus 100 for performing the injection molding method 10 will be described below.

Referring to FIG. 2A, in the molding apparatus 100, a plurality of lower mold cores arranged in a first direction are installed to be movable horizontally along its arrangement direction in the first arrangement step (11), and a plurality of upper mold cores are arranged in the first direction, to be movable in a direction perpendicular to the movement direction of the lower mold cores in the second arrangement step (12). When the upper mold cores move downward while the lower mold cores remain still, at least one of the lower mold cores is brought into contact with one of the upper mold cores. Each upper or lower mold core is connected to a sprue 139. In the exemplary embodiment of the present invention, sprues 139 are connected to the upper mold cores.

In FIG. 2A, the molding apparatus 100 is provided with two pairs of lower mold cores and two pairs of upper mold cores. In accordance with the exemplary embodiment of the present invention, an injection-molded part, specifically the front cover 201 shown in FIG. 9 is fabricated using only one pair of lower mold cores 121 and 123 and one pair of upper mold cores 131 and 133. Hence, although the molding apparatus 100 shown in FIG. 2A, FIG. 2B, FIG. 2C, FIG. 3A, FIG. 3B, FIG. 3C, FIG. 4A, FIG. 4B, FIG. 4C, FIG. 5A, and FIG. 5B is shown to have two pairs of lower mold cores and two pairs of upper mold cores, reference numerals indicate part of them.

The lower mold cores are mounted to be movable horizontally on a mold support 101. While the lower mold cores may be installed to move horizontally on their own, a first core base 102 to contain the lower mold cores may be installed on the mold support 101 so that it may move linearly. The lower mold cores are mounted in the first core base 102 and arranged in the movement direction of the first core base 102. As the first core base 102 moves horizontally, at least one of the lower mold cores moves to a position where it faces one of the upper mold cores and the facing lower and upper mold cores are brought into contact for injection molding.

While an operator can manually move the first core base 102 to a desired position, the first core base 102 may alternatively be moved to a position by use of a separate driver.

The driver is operated by an oil hydraulic cylinder 104 or a driving motor (not shown). A rod 141 (shown in FIG. 4C) extending along the movement direction of the first core base 102 is connected to the oil hydraulic cylinder 104 or the driving motor. The rod 141 has an end fixed to the first core base 102 and moves lengthwise along with the operation of the oil hydraulic cylinder 104 or the driving motor, thus moving the first core base 102.

The second lower mold core 123 may move horizontally on the mold support 101 to a position where it faces one of the upper mold cores of the two pairs.

That is, the first core base 102 horizontally moves on the mold support 101 from a first position where it faces one of the upper mold cores to a second position where the second lower mold core 123 faces the second upper mold core 133. The first core base 102 is at the first position in FIG. 2A, FIG. 2B, and FIG. 2C and is at the second position in FIG. 4A, FIG. 4B, and FIG. 4C.

To install the upper mold cores, the mold apparatus 100 is further provided with a second core base 103. The second core base 103 moves up and down, facing the mold support 101. The upper mold cores are arranged in the arrangement direction of the lower mold cores and contained in the second core base 103. Thus, the upper mold cores move perpendicularly to the movement direction of the lower mold cores. An apparatus for lifting the second core base 103 up and down is not shown.

At least one lower mold core is sequentially brought into contact with a corresponding upper mold core, and different injection-molded parts are produced according to the contacted mold cores and attached to a pre-molded part. For molding another part and attaching it to the pre-molded part, the pre-molded part may be transferred from the first lower mold core 121 to the second lower mold core 123 or any other lower mold core, or from the first upper mold core 131 to the second upper mold core 133 or any other upper mold core. The transfer is possible by maintaining the pre-molded part inserted in one of the upper or lower mold cores.

That is, when the pre-molded part is hardened and the upper mold cores are detached from the lower mold cores, the pre-molded part is removed from the first lower mold core, while being inserted in the one of the upper mold cores that is in contact with the first lower mold core 121, or the pre-molded part is removed from the upper mold cores, while being inserted in the first lower mold core 121.

The injection molding method 10 using the molding apparatus 100 is performed sequentially by the first arrangement step (11), the second arrangement step (12), the first molding step (14), the second molding step (15), and the third molding step (16). When needed, parts molded in the molding steps may be changed. A final injection-molded part is ejected in the ejection step (18) after the molding steps.

As described above, the lower mold cores are arranged to be movable horizontally on the mold support 101 in the first arrangement step (11). The lower mold cores with the shapes of intended injection-molded parts patterned therein are mounted on the first core base 102 that moves horizontally on the mold support 101.

In the second arrangement step (12), the upper mold cores are contained in the second core base 102. The upper mold cores are arranged in the direction in which the lower mold cores are arranged.

In the first and second arrangement steps (11) and (12), the positions at which movement of the first core base 102 is to be stopped are set. Thus, the preparation for injection molding is completed. Unless the mold is worn away or a desired product is modified, the layout of the upper and lower mold cores should not need to be changed. Therefore, there is no need to repeat the first and second arrangement steps (11) and (12) each time injection molding is performed.

In accordance with an exemplary embodiment of the present invention, the window 213 to allow the screen to be viewed and the keypad 215 to provide an input function are attached to the frame 211 in the front cover 201 to be fabricated by the molding apparatus 100. Depending on the product, the outer circumferential surface of the frame 211 may be coated with the coating 217. The frame 211 has openings in which the window 213 and the keypad 215 are to be positioned.

FIG. 2A, FIG. 2B, and FIG. 2C sequentially show an injection molding in the first molding step (14) and the resulting injection-molded part is shown in FIG. 6.

During the first molding step (14), the frame 211 is molded and simultaneously, the window 213 is attached to the frame 211. The first lower mold core 121 is brought into contact with the upper mold core 131 to thereby mold the frame 211. The window 213 is pre-molded using a transparent material, for example, acryl, and is pre-arranged in the first upper or lower mold core 131 or 121, for multi-shot injection molding.

When the window 213 is put in the first upper or lower mold core 131 or 121 and the first lower mold core 121 faces the first upper mold core 131, the second core base 103 descends so that the first lower and upper mold cores 121 and 131 are in contact. Then, melted resin is introduced in the cavity defined by the first lower and upper mold cores 121 and 131 through the sprue 139. As the resin is hardened, the frame 211 attached with the window 213 is molded, as shown in FIG. 6. In the description of the exemplary embodiment of the present invention, the injection-molded part with the window 213 attached thereto is called the first frame 201a. FIG. 2C shows a state where the first frame 201a is molded and then as the second core base 103 goes up, the first lower mold core 121 is opened.

During the second molding step (15), the coating 217 is molded and attached to the first frame 201a. This step may be repeated according to the number of molded parts to be attached to the first frame 201a. The exemplary embodiment of the present invention takes the coating 217 as an example of a molded part to be attached to the first frame 201a. Depending on a product, decorative parts may be molded and attached around a receiver or the keypad.

FIG. 3A and FIG. 3B sequentially show molding of the coating 217 in the second molding step (15). The coating 217 is coated on the outer circumferential surface of the first frame 201a, except in the region of the window 213, to enhance the looks of an electronic device, such as a portable phone. The shape of the circumferential surface of the front cover 201 is formed by the upper mold cores. With the first frame 201a in the first lower mold core 121, the coating 217 is molded by the second upper mold core 133.

That is, when the first frame 201a is completely molded, the lower mold cores are opened and the first core base 102 is moved horizontally. Then, the coating 217 is molded by bringing the first lower mold core 121 into contact with the second upper mold 133. While the first frame 201a is kept in the first lower mold core 121, the first lower mold core 121 is brought into contact with the second upper mold core 133 and melted resin is introduced into the cavity between the first lower mold core 121 and the second upper mold core 133, thus molding the coating 217.

The first frame 201a with the coating 217 applied thereto is shown in FIG. 7. The injection-molded part with the coating 217 is called the second frame 201b. After the coating 217 is molded, the keypad 215 may be attached. The keypad 215 is molded separately from the second frame 201b and attached onto the inner circumferential surface of the second frame 201b in one of the openings of the second frame 201b. When the lower mold cores are opened after the molding of the second frame 201b, the second frame 201b is inserted into the second upper mold core 133. Hence, the second frame 201b is not shown in FIG. 3C.

FIG. 4A, FIG. 4B, and FIG. 4C sequentially show the process of attaching the keypad 215 to the second frame 201b in the third molding step (16). The third molding step (16) is similar to the second molding step (15), but the lower mold core used in the third molding step (16) is different from the lower mold core used in the second molding step (15). In FIG. 4A, the pre-molded keypad 215 is positioned in the second lower mold core 123. Here, the second frame 201b remains inserted in the second upper mold core 133 as a result of the second molding step (15).

When the second core base 103 moves up with the second frame 201b inserted in the second upper mold core 133, the first core base 102 moves horizontally, thus moving the second lower mold core 123 to face the second upper mold core 133, as shown in FIG. 4A. Here, the pre-molded keypad 215 is positioned in the second lower mold core 123.

When the second lower and upper mold cores 123 and 133 are brought into contact, the keypad 215 is positioned in one of the openings of the second frame 201b, and melted resin is introduced and hardened between the periphery of the keypad 125 and the second frame 201b. As a consequence, the keypad 215 and the second frame 201b are sealed together, which may allow them to be waterproof.

FIG. 4C shows a state where the lower mold cores are opened with the keypad 215 attached to the second frame 201b, and FIG. 8 shows the second frame 201b with the keypad 215 attached thereto. Hereinbelow, the injection-molded part with the molded keypad 215 attached thereto is referred to as a third frame 201c.

While it has been described above that the attachment of the keypad 215 to the second frame 201b is performed by positioning the keypad 215 in the second lower mold core 123 and then bringing the second upper mold core 133 into contact with the second lower mold core 123, it may be further contemplated that the keypad 215 is positioned to be assembled to the second frame 201b rather than positioned in the second lower mold core 123, the second lower mold core 123 is brought into contact with the second upper mold core 133, and then the keypad 215 is sealed in the second frame 201b.

Depending on the number of parts to be attached to the frame 211 and its attachment scheme, the first, second, and third molding steps (14), (15), and (16) are repeated, and other molded parts may be attached to the third frame 201c by changing which lower and upper mold cores are in contact. For example, a decorative part may be inserted into a product, for injection molding.

As shown in FIG. 9, the keys 219a and 219b may be separately molded for the keypad 215 of the front cover 201. After being molded separately, the keys 219a and 219b are attached to the third frame 201c. The keys 219a and 219b may include a search key to invoke a menu and search for information, a start key, an end key, or a hot key to invoke a multimedia function. The keys 219a and 219b also may provide a decorative effect to the keypad 215.

FIG. 5A shows the ejection step (18) to remove the third frame 201c from the molding apparatus 100. After the third frame 201c is removed from the molding apparatus 100, the first core base 102 is moved horizontally to the position where the first molding step (14) can be performed, or to the position where the first arrangement step (11) may be performed to arrange the lower and upper mold cores for to mold another product, as shown in FIG. 5B.

As is apparent from the above description, the molding apparatus and the injection molding method using the same according to exemplary embodiments of the present invention arrange a plurality of lower mold cores in a row to be movable horizontally so that they can be brought into close contact with different upper mold cores according to their positions. Therefore, different parts may be molded according to lower and upper mold cores in close contact or another part can be attached to a pre-molded part, thus facilitating fabrication of a case for a portable electronic device. As the part tightly contacts the pre-molded part simultaneously with its hardening, waterproofing may be achieved during the molding.

Since the processes of molding a plurality of parts and attaching them to a pre-molded part may be simultaneously carried out in a single molding apparatus, fabrication cost may be reduced and fabrication of a waterproof injection-molded product may be facilitated.

Furthermore, exemplary embodiments of the present invention may obviate the need to carry a waterproof pack, thereby enhancing user convenience.

For better understanding of the present invention, an exemplary embodiment of the present invention has been described in the context of fabricating a case of a portable phone as a portable electronic device, in which the window is multi-shot injection-molded simultaneously with molding of the frame of the case, and the coating, the keypad, and decorative parts are inserted, sealed, and attached to the frame by repeating the second molding step. Yet, the present invention is not limited to fabrication of a portable phone. Rather, it is applicable to molding of any product as long as the product includes a part fabricated by injection molding, in addition to portable electronic devices including an electronic notepad, a home-use wired phone, and a portable multimedia player.

Also, while the case is completed by molding and attaching the window, the keypad, and the coating to the frame of the case in the above description, considering that the portable device can serve as an accessory, other injection-molded parts may be attached as decorations to the frame by injection molding according to exemplary embodiments of the present invention.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A molding apparatus, comprising:
a plurality of lower mold cores arranged in a first direction; and
a plurality of upper mold cores arranged in a row in the first direction,
wherein at least one lower mold core is moveable to a first position corresponding to a first upper mold core and to a second position corresponding to a second upper mold core.

2. The molding apparatus of claim 1, further comprising:
a mold support;
a core base on the mold support and movable in the first direction, the core base containing the lower mold cores; and
a driver in the mold support to move the core base in the first direction.

3. The molding apparatus of claim 2, wherein the driver comprises:
one of an oil hydraulic cylinder and a driving motor installed in the mold support; and
a rod having an end fixed to the core base and extending along the first direction,
wherein the rod moves in the first direction in response to operation of the one of the oil hydraulic cylinder and the driving motor.

4. The molding apparatus of claim 1, wherein a frame molded by bringing one of the upper mold cores and one of the lower mold cores into contact with each other is detached from one of the contacted upper and lower mold cores, while being inserted in the other of the contacted upper and lower mold cores, when the contacted upper and lower mold cores are separated from each other.

5. The molding apparatus of claim 1, wherein the lower mold cores and the upper mold cores are sequentially brought into contact with each other while the lower mold cores move in the first direction, a frame is molded by pre-arranging a window in one of the first lower mold core and the first upper mold core that are initially brought into contact while the window is attached to the frame, and a keypad is attached to the frame by bringing the first upper mold core and a second lower mold core into contact with each other with the frame being inserted in the first upper mold core.

6. The molding apparatus of claim 5, wherein the keypad is attached and sealed to the frame by arranging the pre-molded keypad in the second lower mold core, bringing the first upper mold core and the second lower mold core into contact with each other, introducing resin between contact surfaces of the keypad and the frame, and hardening the resin.

7. An injection molding method, comprising:
performing a first molding step for molding a frame by bringing a first lower mold core and a first upper mold core into contact with each other, the first lower mold core being one of a plurality of lower mold cores arranged in a row in a first direction, and the first upper mold core being one of a plurality of upper mold cores arranged in a row in the first direction; and
performing a second molding step by bringing the first lower mold core and a second upper mold core into contact with each other while the frame is positioned in the first lower mold core, or by bringing the first upper mold core and a second lower mold core into contact with each other while the frame is positioned in the first upper mold core.

8. The injection molding method of claim 7, before the first molding step, further comprising:
performing a first arrangement step for arranging the lower mold cores in a row in the first direction to be movable in the first direction; and
performing a second arrangement step for arranging the upper mold cores to be movable in a second direction perpendicular to the first direction so that at least one of the lower mold cores can be selectively moved to a contact position with the upper mold cores.

9. The injection molding method of claim 8, wherein the first arrangement step comprises mounting a core base to be moveable in the first direction on a mold support, the core base containing the lower mold cores.

10. The injection molding method of claim 9, wherein the first arrangement step further comprises:
installing one of an oil hydraulic cylinder and a driving motor a rod having an end fixed to the core base in the mold support,
the rod moving in the first direction according to the operation of the one of the oil hydraulic cylinder and the driving motor.

11. The injection molding method of claim 7, wherein the first molding step comprises pre-arranging a window in one of the first lower mold core and the first upper mold core and attaching the window to the frame while molding the frame.

12. The injection molding method of claim 7, wherein the second molding step comprises bringing the first lower mold core with the frame and the second upper mold core into contact with each other by moving the lower mold cores in the first direction and molding a coating on a surface of the frame to be attached to the surface of the frame.

13. The injection molding method of claim 7, wherein the second molding step comprises bringing the first upper mold core with the frame and the second lower mold core into contact with each other by moving the lower mold cores in the first direction and attaching a keypad to the frame, wherein the keypad is in an already molded state and is inserted in the second lower mold core before the first upper mold core and the second lower mold core are brought into contact with each other.

14. The injection molding method of claim 13, wherein the second molding step further comprises introducing resin between contact surfaces of the frame and the keypad and hardening the resin to attach and seal the keypad to the frame.

15. The injection molding method of claim 8, wherein:
the first arrangement step comprises arranging the lower mold cores including a first lower mold core and a second lower mold core;
the second arrangement step comprises arranging the upper mold cores including a first upper mold core and a second upper mold core;
the first molding step comprises arranging a pre-molded window in one of the first upper mold core and the first lower mold core, bringing the first lower mold core and the first upper mold core into contact with each other, and molding a frame with the pre-molded window attached; and
the second molding step comprises bringing the first lower mold core with the frame and the second upper mold core into contact with each other, molding a coating, and attaching the coating to an outer circumferential surface of the frame.

16. The injection molding method of claim 8, wherein:
the first arrangement step comprises arranging the lower mold cores including a first lower mold core and a second lower mold core;
the second arrangement step comprises arranging the upper mold cores including a first upper mold core and a second upper mold core;
the first molding step comprises arranging a pre-molded window in the first upper mold core, bringing the first lower mold core and the first upper mold core into contact with each other, and molding a frame with the pre-molded window attached; and
the second molding step comprises bringing the first upper mold core with the frame and the second lower mold core into contact with each other and attaching a keypad to the frame, wherein the keypad is in an already molded state and is inserted in the second lower mold core before the first upper mold core and the second lower mold core are brought into contact with each other.

17. The molding apparatus of claim 1, wherein the lower mold cores are movable in the first direction, and the upper mold cores are movable in a second direction, the second direction being perpendicular to the first direction.
